(19) United States
(12) Patent Application Publication
(10) Pub. No.: US 2009/0068369 A1
(43) Pub. Date: Mar. 12, 2009

(54) PROCESS FOR THE FLAME-RETARDANT TREATMENT OF FIBER MATERIALS

(75) Inventors: Salman Dermeik, Augsburg (DE); Reinhold Braun, Schwabmunchen (DE); Karl-Heinz Lemmer, Augsburg (DE); Martin Lung, Mossingen (DE)

Correspondence Address: HUNTSMAN TEXTILE EFFECTS ( GERMANY ) GMBH, LEGAL DEPARTMENT, 10003 WOODLOCH FOREST DRIVE, THE WOODLANDS, TX, 77380, US

(73) Assignee: Huntsman Textile Effects (Germany) GmbH, The Woodlands, TX (US)

(21) Appl. No.: 11/910,106

(22) PCT Filed: Feb. 25, 2006
(86) PCT No.: PCT/EP2006/001750

§ 371 Date: Oct. 21, 2008

(30) Foreign Application Priority Data
Mar. 30, 2005 (EP) 05006920.2

(51) Int. Cl. B05D 5/00

(52) U.S. Cl. 427/412

(57) ABSTRACT

In the case of fiber materials in the form of sheet-like textile structures or yarns, flame-retardant properties can be achieved by applying a polyethylenimine and a phosphonic acid to the fiber materials.

The invention relates to a process for the flame-retardant treatment of fiber materials.

It is known that fiber materials can be treated with certain products in order to impart flame-retardant properties to them. Thus, for example, DE-A 30 03 648 and DE-A 42 44 194 describe the use of nitrogen-containing condensates in papermaking.

EP-A 542 071 describes wood preservatives which contain copper salts and which may additionally contain polyethylenimine and/or phosphonic acid.

The processes known from the prior art for the treatment of fiber materials are not optimum in relation to the flame-retardant treatment of materials containing wool. Often, an adequate flame-retardant treatment cannot be achieved here by known processes and/or the resulting flame-retardant property deteriorates after only a short time when the treated fiber materials come into contact with water.

It was the object of the present invention to develop an improved process for the flame-retardant treatment of fiber materials, it also being possible in particular to impart good flame-retardant effects to fiber materials which contain from 30 to 100% by weight of wool, which effects also have good permanence, i.e. flame-retardant effects which do not deteriorate substantially when the fiber materials come into contact with water.

The object was achieved by a process for the flame-retardant treatment of a fiber material which is present in the form of a sheet-like textile structure or in the form of a yarn and contains less than 20% by weight of cellulose fibers, the fiber material being treated in succession or simultaneously with a component A and a component B, component A being a branched polyethylenimine which contains primary, secondary and tertiary amino groups and which has a weight average molecular weight in the range from 5000 to 1 500 000, preferably from 10 000 to 1 000 000, and in which the numerical ratio of secondary amino groups to primary amino groups is in the range from 1.00:1 to 2.50:1 and the numerical ratio of secondary amino groups to tertiary amino groups is in the range from 1.20; 1 to 2.00:1,

component A being a mixture of such polyethylenimines,
component B being a phosphonic acid of the formula (I), (II) or of the formula (III)

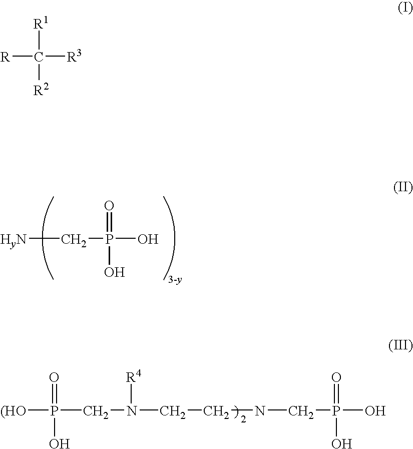

in which, in the formulae (I), (II) or (III), the hydrogen atom in up to 50% of the OH groups bonded to phosphorus may be substituted by an alkali metal or an ammonium group, but preferably 100% of these OH groups being present in unneutralized form,
or component B being a mixture of compounds which are selected from compounds of the formulae (I), (II) or (III),
in which
y may assume the values 0, 1 or 2 and preferably has the value 0,

### R¹ is H or OH,

R is a linear or branched alkyl radical which contains 1 to 7 carbon atoms when R¹ is OH and 3 to 7 carbon atoms when R¹ is H.
R² being

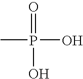

R³ being H or R², preferably R², and
all radicals R⁴, independently of one another, being H or

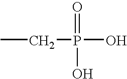

or being a radical of the formula (IV)

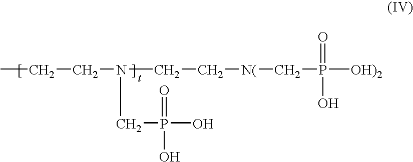

it being preferable if from 50 to 100% of all radicals R⁴ present are

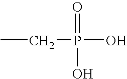

t being 0 or a number from 1 to 10.

In the context of the invention described here, fiber materials are understood as meaning yarns of natural or synthetic fibers or sheet-like textile structures comprising such fibers, it also being possible for blends of such fibers to be present. These materials are preferably free of cellulose fibers but in any case contain less than 20% by weight of cellulose fibers.

The fiber materials preferably comprise from 30 to 100% by weight of wool. The remaining 0 to 70% by weight may be polyolefin fibers, polyacrylonitrile fibers or polyamide fibers. Polyester fibers are less preferred as a blend component for the wool. The fiber materials may have a wool content of less than 30% by weight or be completely free of wool, but this is less preferred. Suitable fibers for these alternatives are once again the abovementioned fibers.

In the process according to the invention, a fiber material is treated in succession or simultaneously with a component A and a component B. Thus, A and B can be applied simultaneously to the fiber material, for example in the form of a mixture which contains the components A and B. It is often advantageous to apply the components A and B in succession, it furthermore being preferable to apply the component A (polyethylenimine earlier to the fiber product than component B (phosphonic acid). It has in fact been found that in many cases a more effective flame-retardant effect can be achieved with this procedure than with the other process variants mentioned.

If it is decided to mix the components A and B before application to the fiber material, i.e. to apply A and B simultaneously to the fiber material, which is particularly suitable when the fiber material comprises a high proportion of wool, it is often advisable to adjust the pH of the mixture before application to the fiber material to a value of more than 4, preferably to a value in the range from 6 to 8. Particularly suitable for this pH control is an aqueous solution of ammonia. It is also possible to use amines for this purpose. With the use of ammonia, it is possible to obtain a mixture of component A, component B and water as a homogeneous aqueous solution which is very suitable for the treatment of the fiber materials by the process according to the invention. The use of ammonia has the advantage that, in a subsequent thermal treatment of the fiber materials, for example at from 110° C. to 180° C., ammonia is removed from the fiber material. The result is good permanence of the flame-retardant treatment.

It is frequently advantageous if the component A and/or the component B is applied to the fiber material not in pure form but in the form of a mixture with water, if thus both component A and component B are applied in each case in the form of a mixture which contains component A or component B and additionally water. Thus, component A can be used, for example, in the form of a mixture which contains from 50 to 500 parts by weight of water per 100 parts by weight of component A, and component B in the form of a mixture which contains from 20 to 300 parts by weight of water per 100 parts by weight of component B. One or both of these mixtures may contain further components, for example polymaleic acid or partly hydrolyzed polymaleic anhydride. The addition of partly or completely hydrolyzed polymaleic anhydride is, when such an additive is used, preferably in the range from 1 to 5% by weight, based on the total mixture which contains the component A or the component B and water.

If polymaleic acid or partly hydrolyzed polymaleic anhydride is used, it is preferably added to a mixture which contains component A and water. In a number of cases, this addition results in an increase in the permanence of the flame-retardant effect. “Permanence” in this context is to be understood as meaning that the flame-retardant properties of the fiber materials are by and large retained even when the fiber material comes into contact with water. This increase in the permanence might be due to the fact that the additional use of partly or completely hydrolyzed polymaleic anhydride leads to better fixing of the component A and/or component B on the fiber material.

It may furthermore be advantageous in some cases additionally to apply a partial ester of orthophosphoric acid to the fiber material. The application of this partial ester can be effected simultaneously with the application of the component A or of the component B or, preferably, separately therefrom in a separate operation. The amount of orthophosphoric partial ester which is applied is preferably in the range from 2 to 10%, based on anhydrous fiber material. Suitable phosphoric partial esters are, inter alia, mono- or diesters of orthophosphoric acid having 6 to 12 carbon atoms in the alcohol component of the ester, or mixtures of such mono- and diesters. An example of this is diisooctyl phosphate or diphenyl phosphate or bis(tert-butylphenyl) phosphate. By the addition of such esters, it is often possible to increase the flame-retardant effect.

Preferably neither component A nor component B nor the mixtures of component A or component B and water contains or contain metals or metal compounds, apart from insignificant impurities. This is an advantage for cost reasons and for environmental reasons, for example in comparison with the known ZIRPRO® process where zirconium compounds are employed, and moreover avoids the coloring of the finished fiber materials by metal ions. Although the hydrogen atom in up to 50% of the hydroxyl groups bonded to phosphorus can optionally be replaced by alkali metal or ammonium ions in component B, this is not preferred.

The application of component A, of component B or of a mixture which also contains water in addition to component A or component B to the fiber material can be effected by any desired methods. It is most advantageous to apply a mixture which contains water and component A and then a mixture which contains water and component B to the fiber material. If the fiber material is present as a sheet-like textile structure, the application can be effected by means of the known padding method. If the fiber material is present in the form of a yarn, the application of the components A and B can be effected by passing the yarn through one or more baths which contain the component A or component B and water and then drying the yarns. However, it is also possible to immerse a bobbin on which the yarn is wound, in the course of a dyeing process, in one or more baths which contain component A and/or component B and then to dry the bobbin.

Regardless of whether the components A and B are each applied as a mixture with water or in pure form to the fiber material, in a preferred embodiment of the process according to the invention the weight ratio of the amount of component A applied to the fiber material to the amount of component B applied is in the range from 1:1.8 to 1:5.0, based in each case on anhydrous products. The ratio is preferably in the range from 1:2.3 to 1:3.5.

The amount of component A and component B which are applied to the fiber material is preferably such that from 3 to 10% by weight of component A and from 7 to 20% by weight of component B, based on anhydrous fiber material, are present on the finished fiber material.

The component A is a polyethylenimine. As usual in the case of polymers, this is usually not a product which consists just of identical molecules but which is a mixture of products of different chain length. In the case of polyethylenimines, there is also the fact, known from the literature, that a mixture of branched polymers whose individual molecules also differ in the number of branching units is usually present. This is expressed by the ratio of the number of secondary to primary amino groups and to tertiary amino groups, which ratio is explained in more detail below.

Polyethylenimines are products known from the literature. They can be prepared, inter alia, by reacting 1,2-ethylenediamine with 1,2-dichloroethane. For carrying out the novel process, polyethylenimines which can be prepared by polymerization of unsubstituted aziridine (ethylenimine) are preferably used. This polymerization can be carried out by known methods, optionally with addition of acidic catalysts, e.g. hydrochloric acid, and optionally in the presence of water.

Polyethylenimines suitable for the process according to the invention are available on the market, for example from BASF, Germany (LUPASOL® grades and POLYMIN® grades).

U.S. Pat. No. 6,451,961 B2 and U.S. Pat. No. 5,977,293 describe polyethylenimines and processes for the preparation thereof. The polyethylenimines described there can be used for carrying out the process according to the invention provided that they fulfill the conditions mentioned above and in claim 1. Furthermore, D. A. Tomalia et al., in “Encyclopedia of Polymer Science and Engineering, Vol. 1, Wiley N.Y. 1985, pages 680-739, describe suitable polyethylenimines and processes for their preparation.

Polyethylenimines, their preparation and properties are also described in D. Horn, “Polyethylenimine-Physicochemical Properties and Applications, in “Polymeric Amines and Ammonium Salts”, Goethals E. J., Pergamon Press: Oxford, New York 1980, pages 333-355.

The polyethylenimines suitable as component A for the process according to the invention are branched. This means that the polymer which has terminal groups of the formula

H₂N—CH₂—CH₂—

and, within the polymer chain, units of the formula

—CH₂—CH₂—NH—CH₂—CH₂—NH—

additionally contains units of the formula

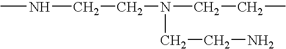

within the chain.

The polymer thus contains primary, secondary and tertiary amino groups.

In order for the procedure of the process according to the invention to give good effects with regard to flame-retardant properties of the fiber products, the numerical ratios of the individual amino groups must assume values within a certain range. Thus, in component A, the ratio of the number of secondary amino groups to the number of primary amino groups must be in the range from 1.00:1 to 2.50:1, and the ratio of the number of secondary amino groups to the number of tertiary amino groups must be in the range from 1.20:1 to 2.00:1. These numerical values can be controlled via the parameters in the preparation of the polyethylenimines.

The values present in a certain polyethylenimine or mixture of polyethylenimines for said numerical ratios of the various amino groups can be determined by means of ¹³C-NMR spectroscopy. This is explained in “T. St. Pierre and M. Geckle, ¹³C-NMR-Analysis of Branched Polyethylenimines, J. Macromol. SCI.-CHEM., Vol. A 22 (5-7). pages 877-887 (1985)”.

Component A, which, as is usual in the case of polymers, is usually a mixture of polymers and consists of polyethylenimine molecules of different molecular weights and different degrees of branching, has a weight average molecular weight in the range from 5000 to 1 500 000, preferably in the range from 10 000 to 1 000 000. The values present in the individual case for this average molecular weight can be determined by methods as disclosed in the polymer literature, for example by means of gel permeation chromatography and detection by means of light scattering. The following procedure may be adopted for this purpose:

The column used comprises one or more “PSS-Suprema” types (obtainable from “Polymer Standards Service GmbH”, Mainz, Germany) which are adjusted to the intended molecular weight range; eluent 1.5% strength formic acid in water; multiangle scattered light detector MALLS (likewise obtainable, inter alia, from “Polymer Standards Service”); an internal standard can optionally additionally be used.

The values mentioned above and in claim 1 for the weight average molecular weight are based on this method of determination.

The average molecular weight of polyethylenimines can be controlled by variation of the parameters in their preparation.

In a preferred embodiment of the process according to the invention, component A is a polyethylenimine which is formed by polymerization of ethylenimine and has the following structure (formula (V))

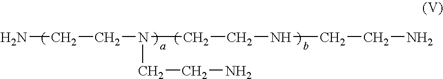

the polymerization optionally being acid-catalyzed,
it being possible for the individual units which contain tertiary amino groups and the individual units which contain secondary amino groups to be arbitrarily distributed over the polymer chain, b being greater than a, and a and b having values such that the conditions mentioned in claim 1 for the molecular weight and for the numerical ratios of the amino groups to one another are fulfilled
or component A being a mixture of such polyethylenimines.

As mentioned, component A is usually a mixture of polyethylenimines. In the abovementioned preferred embodiment, component A is therefore usually a mixture of compounds of the formula (V). The values of a and b in the compounds of the formula (V) must of course be chosen so that the values, determined with the mixture, for the numerical ratios of the individual amino groups to one another and for the average molecular weight are in the ranges stated above and in claim 1. As mentioned, these values can be controlled via the parameters in the preparation of the polyethylenimines.

Component B is a phosphonic acid of the formula (I), of the formula (II) or of the formula (III)

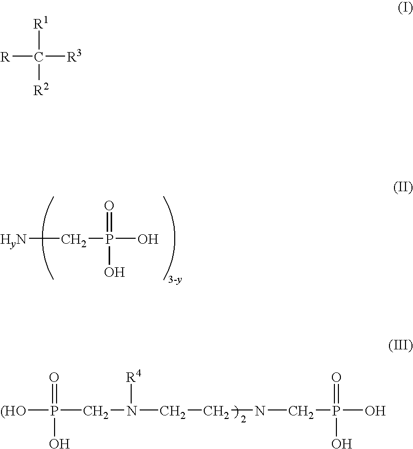

Component B may also be a mixture of compounds which are selected from compounds of the formula (I), of the formula (II) and of the formula (III).

In formula (I), R is a linear or branched alkyl radical. Where the radical R¹ mentioned below is a hydroxyl group, this alkyl radical contains 1 to 7 carbon atoms. If R¹ is hydrogen, the radical R contains 3 to 7 carbon atoms.

The radical R¹ in formula (I) is H or OH.

In formula (I), the radical R² is the radical

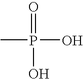

The radical R³ in formula (I) may be hydrogen. Preferably, however, it is a radical R². This ensures that the content of phosphorus, based on the finished fiber product, is higher than when R³═H, with the result that improved flameproofing usually results.

In formula (II), y may assume the values 0, 1 or 2. y preferably has the value 0, which, analogously to the case described above, results in an increase in the phosphorus content based on the fiber product.

All radicals R⁴ present in compounds of the formula (II) are, independently of one another, hydrogen or

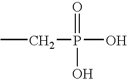

or a radical of the formula (IV)

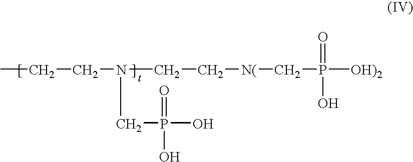

In this formula (IV), t is 0 or is a number from 1 to 10. Preferably, from 50 to 100% of all radicals R⁴ present are

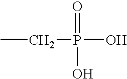

Not all phosphonic acids present in component B need be present in completely unneutralized form. Rather, in up to 50% of the OH groups present and bonded to phosphorus, the acidic hydrogen atoms may be replaced by alkali metal or ammonium ions. Preferably, however, all phosphonic acids of component B are present in completely unneutralized form so that all OH groups are therefore present in acidic form.

Phosphonic acids of the formulae (I), (II) and (III) are commercial products, for example Masquol P 210-1 from Protex-Extrosa or Briquest 301-50 A from Rhodia or the products Cublen D50 (from Zschimmer & Schwarz, Germany), or Diquest 2060 S (from Solutia, Belgium). Phosphonic acids of the formulae (I), (II) and (III) can be prepared by methods generally known from the literature.

A particularly advantageous embodiment of the process according to the invention is characterized in that component B is a mixture of phosphonic acids of the formula (II) and of the formula (III), both of which are present in completely unneutralized form.

In such a mixture, the mixing ratio of phosphonic acid of the formula (II) and phosphonic acid of the formula (III) may assume any desired values. Thus, the weight ratio of the two types of phosphonic acid may assume values of from 0:100 to 100:0. Good results are obtained, for example, if a mixture which contains from 70 to 95% by weight of a compound or a mixture of compounds of the formula (II) and from 5 to 30% by weight of a compound or of a mixture of compounds of the formula (III) is used as component B. It is particularly advantageous here to use a compound of the formula (II), in which

y is 0.

A compound of the formula (I) or a mixture of compounds of the formula (I) or a compound of the formula (II) or a mixture of compounds of the formula (II) or a compound of the formula (III) or a mixture of compounds of the formula (III) can also be used as component B. Particularly good results can be obtained if component B consists of 100% of a compound of the formula (II) or a mixture of compounds of the formula (II), in these cases y in formula (II) having the value 0 or 1.

The fiber materials which are treated by the process according to the invention are present in the form of a sheet-like textile structure or in the form of a yarn. The yarn may consist of continuous filaments or may have been produced from spun fiber by ring spinning or open-end spinning. Suitable sheet-like textile structures are woven fabrics, knitwear or nonwovens. Woven fabrics are preferably used to carry out the process according to the invention. As mentioned above, the fiber materials preferably contain from 30 to 100% by weight of wool. Woven fabrics which consist of 100% of wool are particularly suitable for the process according to the invention. The origin of the wool is not decisive here but the quality of the wool does of course influence the properties of the final article.

The treatment of wool-containing fiber materials can, if desired, be combined with an antimoth treatment, for example by adding a commercial antimoth agent to a treatment bath which contains the components A and B.

The fiber materials treated by the process according to the invention can be used for the production of utility textiles, such as, for example, automobile seats, curtains, carpets, etc.

The invention is now illustrated in more detail by embodiments.

### EXAMPLE 1

### 1a) Preparation of a Mixture which Contains Component A as Claimed in Claim 1

4.8 kg of a commercially available aqueous solution (LUPASOL® P, BASF, Germany), which contained 50% by weight of water and 50% by weight of polyethylenimine, were mixed with 4.8 kg of water and 0.35 kg of a 50% strength aqueous solution of hydrolyzed polymaleic anhydride. The prepared mixture (called “mixture 1a” below) thus contained about 24% by weight of component A.

### 1b) Preparation of a Mixture which Contains Component B as Claimed in Claim 1

9.2 kg of an aqueous solution which contained 40% by weight of water and 60% by weight of a phosphonic acid of the abovementioned formula (I) (where

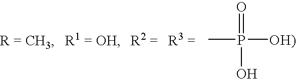

were combined with 0.8 kg of an aqueous solution which contained 50% by weight of water and 50% by weight of a phosphonic acid of the formula (II) (where y=0). The prepared mixture (called “mixture 1b” below) thus contained about 59% by weight of component B.

### EXAMPLE 2

### Example According to the Invention

This example relates to the treatment of fiber materials, which are present in the form of yarns, with components A and B.

In 3 separately performed experiments, 3 different types (2a, 2b, 2c) of spun yarns were each wound on cross-wound bobbins and each installed in a conventional dyeing apparatus. Yarn 2a was a blue, acid-dyed spun yarn comprising 100% of wool, yarn 2b was a brown spun yarn comprising 90% by weight of wool and 10% by weight of polyamide, and yarn 2c was a blue-gray spun yarn comprising 90% by weight of wool and 10% by weight of polyamide. In all 3 experiments, the dyeing apparatus was charged with in each case 10 times the amount of water at room temperature, based on the weight of the relevant yarn (calculated without cross-wound bobbin).

The water was then removed from the apparatus, and mixture 1c was added at room temperature. Mixture 1c contained 50% by weight of mixture 1a (according to example 1a) and 50% by weight of water. Mixture 1c thus contained component A. In all 3 experiments, the amount of added mixture 1c was 12% by weight, based on the weight of the relevant yarn, i.e. based on the weight of yarn 2a or yarn 2b or yarn 2c. In all 3 experiments the cross-wound bobbins were exposed to the action of mixture 1c at room temperature for 10 minutes in the dyeing apparatus. Thereafter, the apparatus was flushed for 5 minutes with water and the flushing water was removed.

Mixture 1d was then introduced into the apparatus at room temperature. Mixture 1d contained 50% by weight of the mixture 1b prepared according to example 1b) and 50% by weight of water. Thus, mixture 1d contained component B). The amount of mixture 1d which was then introduced into the apparatus in each of the 3 experiments was 12% by weight, based on the weight of yarn 2a or yarn 2b or yarn 2c. The cross-wound bobbins were exposed to the action of mixture 1d at room temperature for 10 minutes. Thereafter, the apparatus was flushed twice with water at room temperature in each case. The cross-wound bobbins were then removed from the apparatus in all experiments and dried for 15 minutes at 120° C. One sample each of knitwear was then produced from the respective yarns.

### EXAMPLE 3

### According to the Invention

All 3 experiments of example 2 were repeated with the only difference that the amount of mixture 1c and of mixture 1d which were added to the dyeing apparatus was not 12% by weight, based on yarn weight, but only 6% by weight.

Determinations of the flame-retardant properties were carried out for the 6 samples of knitwear from examples 2 and 3. The determination was carried out according to DIN 4102 B2 in the case of the samples of yarn 2a and yarn 2c, and according to the method “Federal Motor Vehicle Safety Standard (FMVSS) 302” in the case of yarn 2b. This method is described in “Jürgen Troitzsch, International Plastics Flammability Handbook”, 2nd edition 1990, Carl Hanser Verlag, Munich, Germany, pages 289/290. It was found that all samples had very good flame-retardant properties, i.e. the conditions set out in the abovementioned regulations are fulfilled.

### EXAMPLE 4

### According to the Invention

This example relates to the treatment of woven fabrics by the process according to the invention. The woven fabric used was a material comprising 100% of wool, dyed red, 205 g/m². The material was treated by padding with a liquor which was prepared as follows:

35 g of a 25% strength aqueous solution of a polyethylenimine (component A) were mixed with 45 g of a 50% strength aqueous solution of a phosphonic acid of the formula (II) in which y=0 (component B). 21 g of a 22% strength aqueous ammonia solution were added to the mixture. A clear solution of pH 7.5 is formed with stirring. This solution was diluted with water in the weight ratio 1:1. The mixture obtained was used as a padding liquor.

After the padding, drying was effected at 150° C. for 10 minutes. Thereafter, the fiber material contained 9% of deposited solid, i.e. the weight of the fiber material was 9% higher than the weight of the fiber material prior to padding.

### EXAMPLE 5

### According to the Invention

Example 4 was repeated with the difference that, instead of 45 g of the aqueous phosphonic acid solution, only 30 g were used, and that drying was effected not at 150° C. but at 110° C. The deposited solid was 8.6%.

### EXAMPLE 6

### According to the Invention

Example 4 was repeated with the only difference that, instead of a woven fabric comprising 100% of wool, a woven fabric comprising 90% by weight of wool and 10% by weight of polyamide was used.

The flame-retardant properties were determined for the woven fabrics treated according to examples 4, 5 and 6, in particular from the combustion times. The combustion time (CT) designates the time in seconds for which the relevant sample continues to burn after it was exposed to a flame for 3 seconds and this flame was then removed. A higher value for CT thus means poorer flame-retardant properties. The determination of the combustion time was effected according to DIN 54336 (November 1986 edition). The combustion times were determined both for the woven fabric samples which were obtained immediately after the drying mentioned and for the samples of the same origin but which had also been washed after the drying (pure water at 40° C./20 minutes).

The results are shown in table 1

TABLE 1

| Sample according | Combustion time (CT) | Combustion time (CT) in sec, |
|---|---|---|
| to example | in sec, unwashed | washed 40° C./20 minutes |
| 4 | 0 | 0 |
| 5 | 0 | 18 |
| 6 | 0 | 0 |

It is evident that, in the case of example 5, the amount of component B was sufficient to produce good flame-retardant properties on the unwashed woven fabric but that greater deposits of component B are required in order to achieve good permanence with respect to washing processes.

1-8. (canceled)

9. A process for the flame-retardant treatment of a fiber material which is present in the form of a sheet-like textile structure or in the form of a yarn and contains less than 20% by weight of cellulose fibers, the process comprising treating the fiber material in succession or simultaneously with a component A and a component B wherein component A comprises a branched polyethylenimine which contains primary, secondary and tertiary amino groups and which has a weight average molecular weight in the range from 5000 to 1500000 and in which the numerical ratio of secondary amino groups to primary amino groups is in the range from 1.00:1 to 2.50:1 and the numerical ratio of secondary amino groups to tertiary amino groups is in the range from 1.20:1 to 2.00:1 and component B comprises a phosphonic acid of the formula (I), (II) or (III) 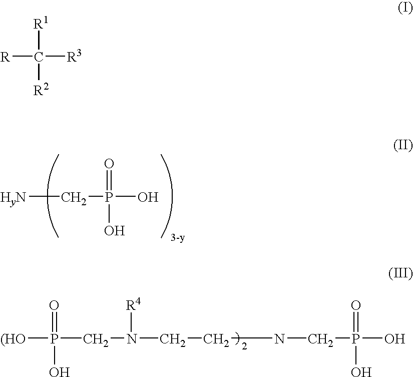
in which, in the formula (I), (II) or (III), in up to 50% of the OH groups bonded to the phosphorus the hydrogen atom may be substituted by an alkali metal or an ammonium group and wherein
y has a value of 0, 1 or 2,
R¹ is H or OH,
R is a linear or branched alkyl radical which contains 1 to 7 carbon atoms when R¹ is OH and 3 to 7 carbon atoms when R¹ is H,
R¹ is 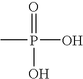
R³ is H or R², and
all radicals R⁴, independently of one another, are H or 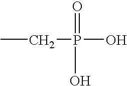
or a radical of the formula (IV) 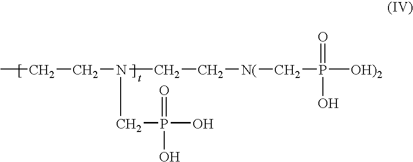
wherein t has a value from 0 to 10.

10. The process of claim 9 wherein component A has a weight average molecular weight in the range from 10000 to 1000000.

11. The process of claim 9, wherein component B comprises a mixture of phosphonic acids of the formula (I), (II) or (III).

12. The process of claim 9, wherein y has a value of 0.

13. The process of claim 9, wherein component B is a mixture of phosphonic acids of the formula (II) and of the formula (III), wherein each phosphonic acid present is in a completely unneutralized form.

14. The process of claim 9, wherein the weight ratio of the amount of component A applied to the fiber product to the amount of component B applied is in the range from 1:1.8 to 1:5.0.

15. The process of claim 9, wherein component A and/or component B are applied in the form of a mixture with water to the fiber material.

16. The process of claim 9, wherein neither component A nor component B contains metals or metal compounds.

17. The process of claim 9, wherein the fiber material comprises from 30 to 100% by weight of wool.

18. The process of claim 9, wherein the fiber material is a woven fabric.

19. The process of claim 9, wherein 50% to 100% of all radicals R⁴ present are [chemical structure]
